(19) United States
(12) Patent Application Publication
(10) Pub. No.: US 2026/0204718 A1
(43) Pub. Date: Jul. 16, 2026

(54) COVER FOR A CELL CONTACT SYSTEM OF AN ELECTRICAL ENERGY STORAGE UNIT

(71) Applicant: MAN Truck & Bus SE, München (DE)

(72) Inventors: Martin WICHTREI, München (DE); Markus LAMPALZER, München (DE); Sebastian KRATZER, MÜNCHEN (DE); Kristijan Begic, München (DE)

(21) Appl. No.: 19/128,500

(22) PCT Filed: Oct. 31, 2023
(86) PCT No.: PCT/EP2023/080310

§ 371 Date: May 8, 2025

(30) Foreign Application Priority Data
Nov. 8, 2022 (DE) 10 2022 129 456.0

(51) Int. Cl. H01M 50/271; H01M 10/42; H01M 50/24; H01M 50/249; H01M 50/342; H01M 50/51

(52) U.S. Cl. CPC H01M 50/271; H01M 10/425; H01M 50/24; H01M 50/249; H01M 50/342; H01M 50/51; H01M 2010/4271; H01M 2220/20

(57) ABSTRACT

The invention concerns a cover (10) for a cell contacting system (12) of an electrical energy storage (100) for a vehicle. The invention further relates to an electrical energy storage (100) and a vehicle comprising the cover (10) or the electrical energy storage (100).

The cover (10) comprises an, preferably plate-shaped, insulator body (14) which is configured to cover the cell contacting system (12) to form a contact protector; and at least one control device (16), preferably cell control device configured for controlling an electrical energy flow via the cell contacting system (12), wherein the at least one control device (16) is at least partially accommodated by the insulator body (14).

The invention concerns a cover for a cell contacting system of an electrical energy storage for a vehicle. The invention also concerns an electrical energy storage and a vehicle comprising the cover or the electrical energy storage.

Vehicle batteries known in practice, such as those used as energy storage or traction batteries in hybrid vehicles or electric vehicles, typically have multiple battery storage cells arranged in a stack, which form one or more battery cell stacks. The cell poles of these battery cell stacks are typically electrically connected or interconnected with a cell contacting system. Cell control devices or cell module controllers (also known as cell management controllers) are also used for controlling the flow of energy. In battery systems in particular, which are composed of multiple battery cell stacks arranged above each other and/or laterally adjacent to each other, so-called multi-layer high-voltage batteries or multilayer batteries, the cell control devices are often positioned laterally adjacent to the battery cell stacks. The cell control devices thus occupy a position in the battery system that is required for further battery cell stacks in a disadvantageous manner. Known systems therefore switch to solutions in which the cell control devices are arranged outside the battery cell stacks or completely outside the electrical energy storage. This entails the main disadvantage, inter alia, that the wiring effort increases and the cell control devices can be damaged more easily by external influences. A more efficient utilization of the required installation space without these disadvantages is particularly desirable for multi-layer high-voltage batteries or multilayer batteries.

In this context, document D1 (U.S. Pat. No. 10,714,717B2 ) proposes a solution in which a cell module controller is integrated into the cell contacting system. This entails the disadvantage, inter alia, that current conducting parts of the cell contacting system are exposed when the cover is removed, e.g. when a defective cell module controller is replaced, and thus pose a danger to bystanding persons. Furthermore, the position of the cell module controller is disadvantageously limited to an arrangement between the cell poles. This position is unfavorably located above venting openings of the battery storage cells, so that in the event of degassing of a battery storage cell, there is an increased risk of damage to the cell module controller due to escaping hot gas.

The objective of the present invention is to provide a technique with which the disadvantages of known approaches can be avoided. In particular, the objective of the invention is to improve known energy storage systems with regard to the required installation space, without compromising the safety of bystanding persons against electric shock and/or without increasing the risk of damage to the cell control devices in the event of degassing.

These objectives are solved by devices with the features of the independent claims. Advantageous modifications are given in the dependent claims and the description.

A basic idea of the invention is to integrate the control device (e.g. at least one cell control device) into an insulator body of a high-voltage cover. In this respect, the control device and the insulator body form a combination component.

One aspect concerns a cover for a cell contacting system of an electrical energy storage for a vehicle.

The cover comprises an (e.g. plate-shaped) insulator body and at least one control device. To form a contact protector (e.g. against electric shock), the insulator body is configured to cover the cell contacting system.

The at least one control device can preferably be designed as a cell control device, which is configured for controlling an electrical energy flow via the cell contacting system. The at least one control device is at least partially accommodated by the insulator body.

One advantage of the invention may be that, in the event of a defect in a control device, the cover as a whole (i.e. the insulator body together with the at least one control device) can be removed and replaced. This can reduce the risk of electric shock to bystanding persons during the disassembly process. At the same time, the integration of the at least one control device into the insulator can constitute an advantageous arrangement option, since the installation space that is laterally freed up adjacent to the battery cell stacks can be used in this way, for example, for further battery cell stacks or otherwise. At the same time, such, the at least one control device is no longer tied to a position above the venting openings, but can be arranged at any suitable position on the insulator body, which can reduce the risk of damage to the at least one control device in the event of degassing. By integrating the at least one control device into the insulator, the required installation space in height direction (Z direction) can also be reduced. Advantageously, two component functions are combined in one component in order to minimize the required installation space.

The at least one control device can be a cell management controller (CMC), for example. The at least one control device can be configured to detect a duration of the electrical energy flow and/or a temperature of the cell contacting system (e.g. in a contacting area to cell poles of a battery cell stack). The insulator body can be, for example, an insulator plate and/or an insulator cover. The connection between the storage cells and the control device can be fixed or detachable.

In one embodiment, the insulator body may comprise at least one recess (e.g. at least one depression). The at least one control device may be fastened in the at least one recess. For example, the at least one recess limits an inner volume and the at least one control device is arranged (e.g. completely) in the inner volume. For example, the insulator body can be a lower housing shell for the control device. This can further reduce the required installation space in height direction.

In one embodiment example, the at least one control device can be recessed and/or embedded (e.g. completely) in the at least one recess. Optionally, an end side (e.g. top side) of the at least one control device opposite the insulator body may be substantially flush with and/or terminate at an end side (e.g. top side) of the insulator body. For example, the end side of the at least one control device opposite the insulator body and the end side of the insulator lie in one plane. It is also conceivable that the at least one control device does not protrude beyond the insulator body. Thereby, the at least one control device can be protected from external damage and/or further reduce the required installation space in height direction.

In one embodiment, the at least one control device can be non-detachably connected to the insulator body. Preferably, the at least one control device is non-detachably connected to the insulator body by means of at least one fastening rivet. Optionally, the insulator body can be designed as a plastic injection-molded part. For example, it is conceivable that the at least one control device is integrated into the insulator body, at least in sections, by overmolding. However, any other suitable method of fastening is also conceivable, for example by means of positive locking (e.g. by means of latching elements) and/or frictional locking (e.g. by pressing the at least one control device into the insulator body) and/or material locking (e.g. by means of adhesive). This has the advantage that the cover can be assembled and disassembled as a one-piece integral component.

In one embodiment, the insulator body may comprise a material that is an electrical non-conductor. For example, the non-conductor comprises a plastic material (such as glass fiber reinforced plastic), a ceramic material, a glass material and/or a silicone material.

Alternatively or additionally, it is conceivable that the at least one control device comprises an electrically insulating protection cap, which is arranged on an end side (e.g. on a top side) of the at least one control device opposite and/or facing away from the insulator body to form a contact protector. Preferably, the end side is essentially flush with an end side (e.g. with a top side) of the insulator body. This can further reduce the risk of electric shock to bystanding persons.

In an embodiment example, the cover may further comprise at least one conductor device which is configured to electrically connect the at least one control device and the cell contacting system. Preferably, the at least one conductor device comprises a flexible conductor foil. This can advantageously reduce the weight of the cover.

It is conceivable that the insulator body comprises at least one through-opening and that the at least one conductor device extends from one side (e.g. from a top side) of the insulator body, on which the at least one control device is arranged, through the at least one through-opening to a side opposite the control device (e.g. to a bottom side) of the insulator body.

In one embodiment example, the at least one control device may comprise multiple control devices. The insulator body may comprise multiple recesses (e.g. multiple depressions). One of the multiple control devices can be fixed in each of the multiple recesses. This can further reduce the wiring effort. Advantageously, for example, control devices for multiple battery cell stacks can also be accommodated by the insulator body.

A further aspect concerns an electrical energy storage. The electrical energy storage comprises a battery cell stack, a cell contacting system and a cover as disclosed herein. The battery cell stack comprises multiple cell poles. The cell contacting system electrically connects and/or interconnects the cell poles (e.g. in series with each other). The insulator body covers the cell contacting system to form a contact protector (e.g. completely and/or substantially flush). Optionally, the electrical energy storage comprises a housing. The battery cell stack, the cell contacting system and the cover are arranged in the housing. The housing may also comprise a housing cover that covers the cover, for example. The battery cell stack can comprise multiple storage cells arranged behind each other in a stack-like manner in stacking direction. However, it is also conceivable that the battery cell stack comprises multiple rows arranged transversely to the stacking direction of storage cells arranged behind each other in a stack-like manner.

In one embodiment, the cell contacting system can be arranged between the cover and the battery cell stack. Thereby, the current-carrying cell contacting system is not exposed, which can further increase electrical safety.

Alternatively or additionally, the at least one recess can be arranged on a side (e.g. top side) of the insulator body opposite and/or facing away from the cell contacting system.

In one embodiment, the insulator body and/or the battery cell stack may comprise at least one venting opening for discharging gas escaping from the battery cell stack. For example, the at least one control device may be arranged so as not to cover the at least one venting opening. Alternatively or additionally, the at least one control device may be arranged so as not to be flush with the at least one venting opening. Alternatively or additionally, the at least one control device may be arranged laterally (e.g. along a direction transversely to a stacking direction of the battery cell stack) offset from the at least one venting opening. This allows the escaping gas to be guided past the at least one control device in the event of degassing of a storage cell. A damaging of the at least one control device by the escaping gas in the event of degassing can be prevented in such a way.

In one embodiment example, the at least one control device may comprise multiple control devices. Alternatively or additionally, the at least one conductor device may comprise multiple conductor devices. The multiple control devices and/or the multiple conductor devices may be arranged offset from each other, as viewed in a stacking direction of the battery cell stack or transversely to a stacking direction of the battery cell stack. This can further reduce the wiring effort.

In an embodiment example, the cell contacting system may comprise a carrier plate and at least one cell pole connector received by the carrier plate. Preferably, the at least one cell pole connector electrically connects a portion of the multiple cell poles (e.g., two of the multiple cell poles) together. The at least one conductor device may electrically connect the at least one cell pole connector and the at least one control device.

In one embodiment example, the electrical energy storage may comprise a further battery cell stack, a further cell contacting system and a further cover as disclosed herein. The further battery cell stack may comprise multiple cell poles. The further cell contacting system may electrically connect (e.g., connect and/or connect in series) the cell poles of the further battery cell stack. The insulator body of the further cover can cover the further cell contacting system to form a contact protector. The further battery cell stack can be arranged laterally adjacent to the battery cell stack or in a stack-like manner above the cover. Thereby, the installation space freed up due to the integration of the at least one control device in the insulator body can be advantageously used for further battery cell stacks, which can increase the capacity of the battery.

Another aspect relates to a vehicle (e.g., motor vehicle) comprising a cover as disclosed herein or an electrical energy storage as disclosed herein. Preferably, the motor vehicle is a utility vehicle. In other words, the utility vehicle may be a motor vehicle that is designed by its design and equipment to transport people, to transport goods or to tow trailer vehicles. For example, the motor vehicle may be a truck, a bus and/or a tractor-trailer combination that is at least partially electrically powered.

The preferred embodiments and features of the invention described above can be combined with one another as desired.

Details and advantages of the invention are described below with reference to the accompanying drawing. It is shown in

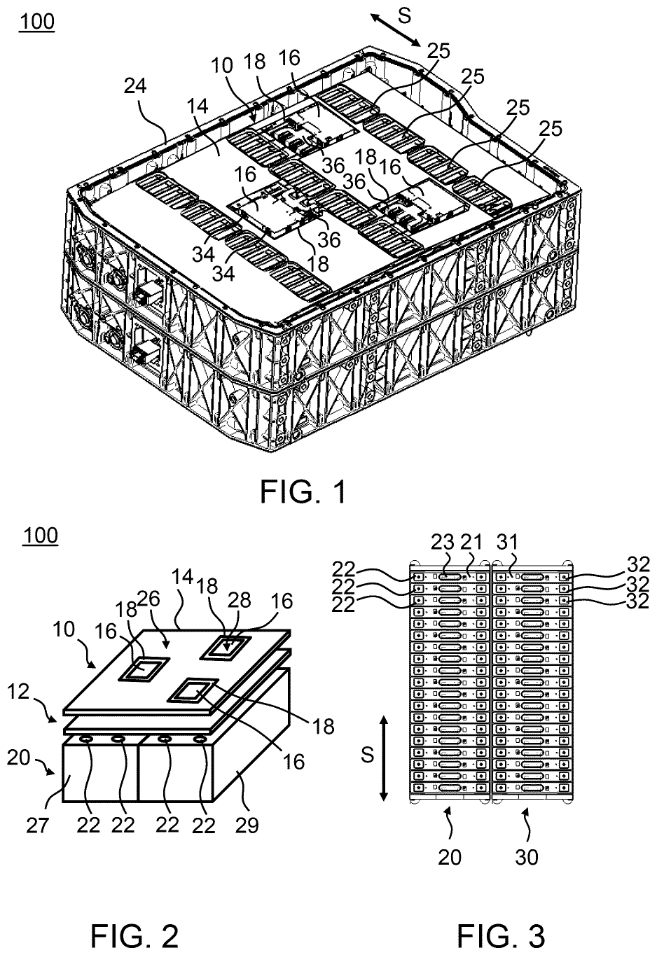

FIG. 1 an electrical energy storage according to one embodiment;

FIG. 2 a schematic exploded view of the electrical energy storage shown in FIG. 1;

FIG. 3 two battery cell stacks of an electrical energy storage according to one embodiment;

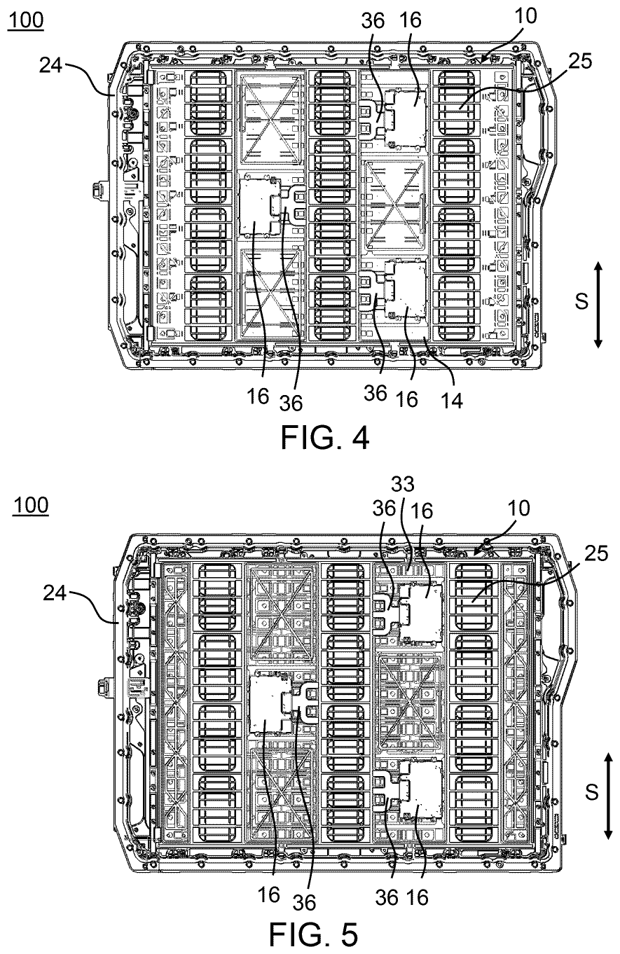

FIG. 4 an electrical energy storage according to one embodiment;

FIG. 5 the electrical energy storage shown in FIG. 4 with a transparent cover;

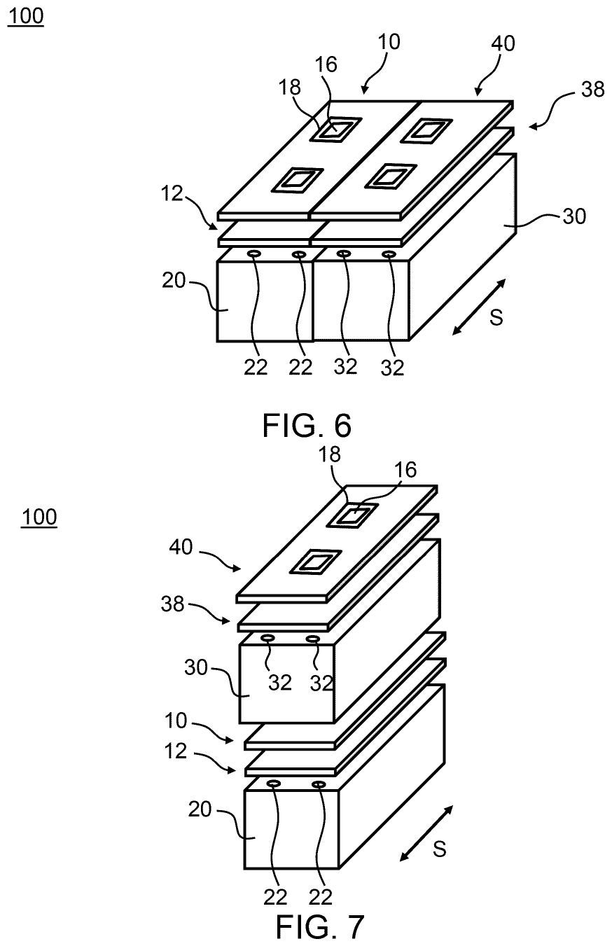

FIG. 6 a schematic exploded view of an electrical energy storage according to one embodiment; and

FIG. 7 a schematic exploded view of an electrical energy storage according to one embodiment.

FIGS. 1 and 2 show (in section) an electrical energy storage 100 for a vehicle (not shown) according to one embodiment.

The electrical energy storage 100 comprises a battery cell stack 20, a cell contacting system 12 and a cover 10 for the cell contacting system 12 of the electrical energy storage 100.

The battery cell stack 20 comprises multiple cell poles 22 (see FIG. 2). The cell contacting system 12 electrically connects and/or interconnects the cell poles 22. Preferably, the cell contacting system 12 electrically connects the cell poles 22 in series. It is conceivable that all cell poles 22 or only some of the cell poles 22 are electrically connected and/or interconnected by the cell contacting system 12.

The cover 10 comprises an insulator body 14 and at least one control device 16. Preferably, it is a plate-shaped insulator body 14. The insulator body 14 can also be designed, for example, as an insulator cover and/or an insulator cap and/or an insulator hood.

To form a contact protector, the insulator body 14 is configured to cover the cell contacting system 12.

Preferably, the at least one control device 16 is configured for controlling an electrical energy flow via the cell contacting system 12. Preferably, the at least one control device 16 is a cell control device. For example, the control device 16 may be a cell management controller (CMC) or cell module controller. It is conceivable that the at least one control device 16 is configured to detect a duration of the electrical energy flow and/or a temperature of the cell contacting system 12 (e.g. in a contacting area of the cell contacting system 12 to the cell poles 22).

The at least one control device 16 is at least partially accommodated by the insulator body 14. For example, the at least one control device 16 is at least partially integrated into the insulator body 14.

In the electrical energy storage 100, the insulator body 14 covers the cell contacting system 12 to form a contact protector. Preferably, the insulator body 14 completely covers the cell contacting system 12.

Optionally, the electrical energy storage comprises a housing 24. The battery cell stack 20, the cell contacting system 12 and the cover 10 can be arranged in the housing 24. The housing 24 may comprise a housing cover (not shown) that covers the cover 10. For example, the housing 24 with the housing cover may (e.g., completely) surround the battery cell stack 20, the cell contacting system 12, and the cover 10.

The insulator body 14 may comprise at least one recess 18. Preferably, the at least one recess 18 is at least one depression. The at least one control device 16 can be fastened in the at least one recess 18. Preferably, the at least one recess 18 limits an inner volume. For example, the at least one control device 16 is arranged in the inner volume (e.g. completely in the inner volume).

The at least one control device 16 can be recessed and/or embedded (e.g. completely) in the at least one recess 18.

As shown in FIG. 1, the at least one control device 16 may comprise multiple control devices 16. Furthermore, the insulator body 14 may comprise multiple recesses 18 (e.g. depressions). Preferably, one of the multiple control devices 16 is fastened in each of the multiple recesses 18.

An end side (e.g., a top side 28, see FIG. 2) of the at least one control device 16 opposite and/or facing away from the insulator body 14 may be flush or terminate flush with an end side (e.g., with a top side 26) of the insulator body 14. For example, the end side of the at least one cell control device 16 opposite and/or facing away from the insulator body 14 and the end side of the insulator body 14 may lie (e.g. substantially) in one plane. It is also conceivable that the at least one control device 16 does not protrude beyond the insulator body 14.

As can be seen in FIG. 2, the cell contacting system 12 can be arranged between the cover 10 and the battery cell stack 20. Furthermore, it is conceivable that the at least one recess 18 is arranged on a side opposite and/or facing away from the cell contacting system 12 (e.g. on the top side 26) of the insulator body 14.

The at least one control device 16 can be non-detachably connected to the insulator body 14. It is conceivable that the at least one control device 16 is non-detachably connected to the insulator body 14 by means of at least one fastening rivet 34 (see FIG. 1). It is also conceivable that the insulator body 14 is designed as a plastic injection-molded part. Optionally, the at least one control device 16 can be integrated into the insulator body 14 at least in sections by overmolding. However, any other suitable method of fastening is also conceivable, for example by means of positive locking (e.g. latching elements) and/or frictional locking (e.g. by pressing the at least one control device 16 into the insulator body 14) and/or material locking (e.g. by means of adhesive).

Optionally, the insulator body 14 comprises a material that is an electrical non-conductor. For example, the non-conductor can be a plastic (e.g. glass fiber-reinforced plastic), a ceramic material, a glass material and/or a silicone material. However, any other material suitable for use as a non-conductor is also conceivable.

The at least one control device 16 may comprise an electrically insulating protection cap. The protection cap may be arranged on an end side opposite and/or facing away from the insulator body 14 (e.g. on a top side 28, see FIG. 2) of the at least one control device 16 to form a contact protector. For example, the protection cap comprises a material that is a non-conductor as described above. Preferably, the top side 28 may be flush with and/or terminate with an end side (e.g., top side 26) of the insulator body 14.

The battery cell stack 20 may comprise multiple storage cells 22 arranged in a stack-like manner one behind the other in a stacking direction S. It is conceivable that the battery cell stack 20 comprises multiple rows 27, 29 of storage cells 22 arranged transversely to the stacking direction S adjacent to each another in a stack-like manner. The rows 27, 29 of storage cells 22 arranged in a stack-like manner behind each other can be covered by a common cover 10 (see FIG. 2).

However, it is also conceivable that the electrical energy storage 100 comprises multiple battery cell stacks 20, 30 (as shown in FIG. 3 as an example, e.g. two battery cell stacks 20, 30), each of which is covered by a cover 10; 40 (see also later explanations with reference to FIGS. 6 and 7).

The cover 10 may comprise a conductor device 36, which is configured to electrically connect and/or interconnect the at least one control device 16 and the cell contacting system 12. Preferably, the at least one conductor device 36 comprises a flexible conductor foil. It is conceivable that the insulator body 14 comprises at least one through-opening. The at least one conductor device 36 can extend from one side (e.g. from the top side 26) of the insulator body 14, on which the at least one control device 16 is arranged, through the at least one through-opening to a side opposite the control device 16 (e.g. to a bottom side) of the insulator body 14. In the case of multiple control devices 16, the insulator body 14 may comprise multiple through-openings, through each of which a conductor device 36 extends.

As can be seen from FIGS. 1, 4 and 5, the insulator body 14 and/or the battery cell stack 20 may comprise at least one venting opening 23; 25 for discharging gas escaping from the battery cell stack 20. The at least one venting opening 23 of the battery cell stack 20 can preferably be flush with the at least one venting opening 25 of the insulator body 14.

It is conceivable that the at least one control device 16 is arranged so as not to cover the at least one venting opening 23; 25. However, it is also conceivable, for example, that the at least one control device 16 is arranged not to be flush with the at least one venting opening 23; 25. Furthermore, it is conceivable that the at least one control device 16 is arranged laterally (e.g. along a direction transversely to the stacking direction S of the battery cell stack 20) offset with respect to the at least one venting opening 23; 25.

It is conceivable that the at least one control device 16 comprises multiple control devices 16 and/or the at least one conductor device 36 comprises multiple conductor devices 36. The multiple control devices 16 and/or the multiple conductor devices 36 may be arranged offset from each other (for example, as viewed in the stacking direction S of the battery cell stack 20 or transversely with respect to the stacking direction S of the battery cell stack 20).

FIGS. 4 and 5 show an electrical energy storage 100 according to one embodiment. In FIG. 5, the cover 10 is shown transparent.

The cell contacting system 12 may comprise a carrier plate and at least one cell pole connector 33 received by the carrier plate. The at least one cell pole connector 33 may electrically connect a portion of the multiple cell poles 22 (e.g., two of the multiple cell poles 22).

Preferably, the at least one cell pole connector 33 may comprise multiple cell pole connectors 33 that connect multiple cell poles 22 of the battery cell stack 20 such that the storage cells 22 of the battery cell stack 20 are connected in series. The at least one conductor device 36 may electrically connect the at least one cell pole connector 33 and the at least one control device 16.

FIGS. 6 and 7 show schematic exploded views of an electrical energy storage 100 according to two embodiments.

In the embodiments of FIGS. 6 and 7, the electrical energy storage 100 may comprise a Further battery cell stack 30. The further battery cell stack 30 may in turn comprise multiple cell poles 32. The electrical energy storage 100 may further comprise a further cell contacting system 38 that electrically connects (e.g., in series) the cell poles 32 of the further battery cell stack 30. The electrical energy storage 100 may further comprise a further cover 40 as disclosed herein. The insulator body 42 of the further cover 40 may cover the further cell contacting system 38 to form a contact protector.

As can be seen from FIGS. 6 and 7, the embodiments shown here differ in the arrangement of the further battery cell stack 30 relative to the battery cell stack 20.

In the embodiment shown in FIG. 6, the Further battery cell stack 30 may be arranged laterally adjacent to the battery cell stack 20.

In the embodiment shown in FIG. 7, the further battery cell stack 30 may be arranged in a stack-like manner above the cover 10.

Conveniently, the vehicle mentioned at the beginning (not shown) may also comprise the cover 10 as disclosed herein. It is further conceivable that the vehicle comprises the electrical energy storage 100 as disclosed herein. Preferably, the vehicle is a motor vehicle.

Although the invention has been described with reference to specific embodiments, it will be apparent to one skilled in the art that various modifications can be made and equivalents can be used as substitutes without departing from the scope of the invention. Consequently, the invention is not intended to be limited to the disclosed embodiments, but is intended to encompass all embodiments falling within the scope of the appended claims. In particular, the invention also claims protection for the subject matter and features of the dependent claims independently of the referenced claims. All range disclosures herein are to be understood as disclosed such that, as it were, all values falling within the respective range are disclosed individually, e.g. also as respective preferred narrower outer limits of the respective range.

### LIST OF REFERENCE SIGNS

10 cover
12 cell contacting system
14 insulator body
16 control device
18 recess
20 battery cell stack
21 storage cell
22 cell pole
23 venting opening of the battery cell stack
24 housing
25 venting opening of the insulator body
26 top side of the insulator body
27 row of the battery cell stack
28 top side of the control device
29 row of the battery cell stack
30 further battery cell stack
31 storage cell
32 cell pole
33 cell pole connector
34 fastening rivet
36 conductor device
38 further cell contacting system
40 further cover
42 insulator body of the further cover
100 electrical energy storage

1-15. (canceled)

16. A cover for a cell contacting system of an electrical energy storage device for a vehicle, wherein the cover comprises:
an insulator body which is configured to cover the cell contacting system to form a contact protector; and
at least one control device, wherein the at least one control device is at least partially accommodated by the insulator body.

17. The cover according to claim 16, wherein the insulator body comprises at least one recess and the at least one control device is fastened in the at least one recess.

18. The cover according to claim 17, wherein:
the at least one control device is recessed and/or embedded in the at least one recess; and/or
an end side of the at least one control device opposite the insulator body is substantially flush with an end side of the insulator body.

19. The cover according to claim 18, wherein:
the insulator body is plate-shaped; and/or
the control device is a cell control device configured for controlling an electrical energy flow via the cell contacting system; and/or
the at least one recess is at least one depression; and/or
the at least one recess limits an inner volume and the at least one control device is arranged in the inner volume; and/or
the at least one control device is completely recessed and/or embedded in the at least one recess; and/or
a top side of the at least one control device opposite the insulator body is substantially flush with a top side of the insulator body.

20. The cover according to claim 16, wherein the at least one control device is non-detachably connected to the insulator body.

21. The cover according to claim 20, wherein:
the at least one control device is non-detachably connected to the insulator body by means of at least one fastening rivet; and/or
the insulator body is designed as a plastic injection-molded part; and/or
the at least one control device is integrated into the insulator body at least in sections by overmolding.

22. The cover according to claim 16, wherein
the insulator body comprises a material which is an electrical non-conductor; and/or
the at least one control device comprises an electrically insulating protection cap which is arranged on an end side of the at least one control device opposite the insulator body to form a contact protector.

23. The cover according to claim 16, further comprising at least one conductor device which is configured to electrically connect the at least one control device and the cell contacting system.

24. The cover according to claim 23, wherein the insulator body comprises at least one through-opening and the at least one conductor device extends from one side of the insulator body, on which the at least one control device is arranged, through the at least one through-opening to a side of the insulator body opposite the control device.

25. The cover according to claim 24, wherein:
the at least one conductor device comprises a flexible conductor foil; and/or
the at least one conductor device extends from top side of the insulator body through the at least one through-opening to a bottom side of the insulator body opposite the control device.

26. The cover according to claim 16, wherein the at least one control device comprises multiple control devices and the insulator body comprises multiple recesses, wherein one of the multiple control devices is fastened in each of the multiple recesses.

27. The cover according to claim 16, wherein:
the at least one control device comprises an electrically insulating protection cap which is arranged on a top side of the at least one control device opposite the insulator body to form a contact protector, and which is substantially flush with a top side of the insulator body; and/or
the at least one control device comprises multiple control devices and the insulator body comprises multiple recesses wherein the multiple recesses are multiple depressions, wherein one of the multiple control devices is fastened in each of the multiple depressions.

28. An electrical energy storage device comprising:
a battery cell stack comprising multiple cell poles;
a cell contacting system electrically connecting the cell poles; and
a cover according to claim 16, wherein the insulator body covers the cell contacting system to form a contact protector; and optionally
a housing in which the battery cell stack, the cell contacting system and the cover are arranged.

29. The electrical energy storage device according to claim 28, wherein:
the cell contacting system is arranged between the cover and the battery cell stack; and/or
at least one recess is arranged on a side of the insulator body opposite the cell contacting system.

30. The electrical energy storage according to claim 28, wherein the insulator body and/or the battery cell stack comprises at least one venting opening for discharging gas escaping from the battery cell stack, and the at least one control device:
is arranged so as not to cover the at least one venting opening; and/or
is arranged so as not to be flush with the at least one venting opening; and/or
is arranged laterally offset from the at least one venting opening.

31. The electrical energy storage according to claim 28, wherein the at least one control device comprises multiple control devices and/or the at least one conductor device comprises multiple conductor devices, wherein the multiple control devices and/or the multiple conductor devices are arranged offset from each other as viewed in a stacking direction of the battery cell stack or as viewed transversely to a stacking direction of the battery cell stack.

32. The electrical energy storage according to claim 28, wherein the cell contacting system comprises a carrier plate and at least one cell pole connector received by the carrier plate.

33. The electrical energy storage according to claim 28, comprising
a further battery cell stack comprising multiple cell poles;
a further cell contacting system electrically connecting the cell poles of the further battery cell stack, preferably in series; and
a further cover, wherein the insulator body of the further cover covers the further cell contacting system to form a contact protector and the further battery cell stack is arranged laterally adjacent to the battery cell stack or in a stack-like manner above the cover.

34. The electrical energy storage according to claim 28, wherein
the cell contacting system electrically connects the cell poles in series; and/or
at least one recess is arranged on a top side of the insulator body opposite the cell contacting system; and/or
the insulator body and/or the battery cell stack comprises at least one venting opening for discharging gas escaping from the battery cell stack, and the at least one control device: is arranged so as not to cover the at least one venting opening; and/or is arranged so as not to be flush with the at least one venting opening; and/or is arranged along a direction transversely to a stacking direction of the battery cell stack, offset from the at least one venting opening; and/or
the cell contacting system comprises a carrier plate and at least one cell pole connector received by the carrier plate, wherein the at least one cell pole connector electrically connects two of the multiple cell poles, and the at least one conductor device electrically connects the at least one cell pole connector and the at least one control device.

35. A vehicle comprising a cover according to claim 16.

36. The vehicle of claim 35, wherein the vehicle is a motor vehicle.

37. A vehicle comprising an electrical energy storage according to claim 28.
